(19) United States
(12) Patent Application Publication
(10) Pub. No.: US 2012/0297845 A1
(43) Pub. Date: Nov. 29, 2012

(54) URICASE INHIBITOR

(75) Inventors: Hibiki Matsushita, Nagoya-shi (JP); Daishi Takada, Nagoya-shi (JP); Nobuki Tada, Miyoshi-shi (JP)

(73) Assignee: TOYOTA JIDOSHA KABUSHIKI KAISHA, Toyota-shi, Aichi (JP)

(21) Appl. No.: 13/576,904

(22) PCT Filed: Jan. 18, 2011
(86) PCT No.: PCT/JP2011/050687

§ 371 Date: Aug. 2, 2012

(30) Foreign Application Priority Data
Feb. 3, 2010 (JP) 2010-022066

(51) Int. Cl. C05F 17/00; C09K 15/34

(52) U.S. Cl. 71/8; 252/398

(57) ABSTRACT

An object of the present invention is to provide a uricase inhibitor for preventing ammonia generation from uric acid. Specifically, the present invention relates to a uricase inhibitor comprising at least one uricase-inhibiting substance selected from the group consisting of eucalyptus, a eucalyptus extract, bamboo vinegar, and corn steep liquor.

### TECHNICAL FIELD

The present invention relates to a uricase inhibitor and a method for producing compost that is inhibited from generating an ammonia odor, for example.

### BACKGROUND ART

Hitherto, compost production has been carried out using excrement, such as poultry excrement discharged during poultry farming. However, poultry excrement contains uric acid, which accounts for about half of the total nitrogen content thereof. Uric acid contained in poultry excrement causes ammonia generation during composting. Therefore, in order to prevent generation of an unusual odor from compost produced using poultry excrement, Patent Document 1 discloses, for example, a poultry manure produced by adding an acidic substance or an aromatic substance to poultry excrement for odor reduction.

One major reason for ammonia generation during composting is that uric acid is converted to allantoin through a uricase reaction induced by a microorganism, allantoin is converted to allantoic acid and then urea, and this results in ammonia generation.

Patent Document 2 discloses, as uricase inhibitors, metals such as silver, copper, and zinc, and metal ions thereof. However, if composting is carried out using such metal or metal ions thereof, the crop produced using the obtained compost disadvantageously contains the metal or the metal ions.

### PRIOR ART DOCUMENTS

### Patent Documents

Patent Document 1: JP Patent Publication (Kokai) No. 2001-89272 A

Patent Document 2: JP Patent Publication (Kokai) No. 5-137774 A (1993)

### SUMMARY OF INVENTION

### Problems to be Solved by the Invention

Hitherto, no method for sufficiently removing an ammonia odor that is generated during composting of excrement containing uric acid, such as poultry excrement, has been known. In addition, no substance available for composting and capable of inhibiting uricase (which causes generation of such ammonia odor) has been known.

Therefore, in view of the above circumstances, the present invention is intended to provide a uricase inhibitor and a method for producing compost that is inhibited from generating an ammonia odor. Means for Solving the Problems

As a result of intensive studies in order to achieve the above object, the present inventors found that eucalyptus, a eucalyptus extract, bamboo vinegar, and corn steep liquor (hereinafter referred to as “CSL”) have uricase-inhibitory effects. This has led to the completion of the present invention.

Specifically, the present invention relates to a uricase inhibitor comprising at least one uricase-inhibiting substance selected from the group consisting of eucalyptus, a eucalyptus extract, bamboo vinegar, and CSL.

In addition, the present invention relates to a method for producing compost comprising a step of composting excrement containing uric acid to which at least one uricase-inhibiting substance selected from the group consisting of eucalyptus, a eucalyptus extract, bamboo vinegar, and CSL is added, or the compost produced by such method.

An example of the above eucalyptus extract is a hot water extract of eucalyptus. In addition, an example of the above excrement is poultry excrement.

This description includes part or all of the contents as disclosed in the description of Japanese Patent Application No. 2010-022066, which is a priority document of the present application.

### Advantageous Effects of Invention

According to the present invention, compost having a slight or no ammonia odor can be produced by inhibiting uricase activity of a uricase-producing bacterium during composting. In addition, according to the present invention, a compost with a high nitrogen content can be produced by inhibiting uric acid degradation.

### EMBODIMENTS FOR CARRYING OUT THE INVENTION

The present invention is described in detail below.

The present invention relates to a uricase inhibitor comprising at least one uricase-inhibiting substance selected from the group consisting of eucalyptus, a eucalyptus extract, bamboo vinegar, and CSL (hereinafter sometimes simply referred to as a “uricase-inhibiting substance”). The use of the uricase inhibitor of the present invention enables inhibition of uricase activity of a uricase-producing bacterium during composting, making it possible to produce compost having a slight or no ammonia odor. In addition, when the uricase inhibitor of the present invention is applied to a restroom floor or the like, uric acid contained in scattered urine droplets on the floor can be prevented from being degraded into ammonia, thereby allowing reduction of an ammonia odor in a restroom.

The term “eucalyptus” used herein refers to plants belonging to the genus Eucalyptus of the family Myrtaceae. Examples of the species belonging to the genus Eucalyptus of the family Myrtaceae include Eucalyptus cinerea, Eucalyptus gunnii, Eucalyptus perriniana, Eucalyptus amygdalina Labill, Eucalyptus leucoxylon F. Muell., Eucalyptus globulus Labill., and Eucalyptus Citriodora. In addition, examples of portions of eucalyptus to be used include the leaves, stems, roots, and bark of the eucalyptus, and a eucalyptus plant as a whole. Further, a eucalyptus plant to be used may be obtained by cutting or it may be dried eucalyptus.

The term “eucalyptus extract” used herein refers to an extract obtained by subjecting the above eucalyptus to extraction with hot water or an organic solvent such as ethanol, methanol, or hexane. For example, hot water extraction is carried out by adding water to dried eucalyptus leaves (for example, content of dried eucalyptus leaves in water: 5% to 20% (W/V)), followed by heating at 70° C. to 100° C. (and preferably 95° C. to 100° C.) for 0.5 to 4 hours (e.g., 2 hours). Further, the obtained extraction liquid is cooled and filtered. The filtrate is lyophilized. Thus, a hot water extract of eucalyptus can be obtained. Meanwhile, organic solvent extraction is carried out by adding an organic solvent to dried eucalyptus leaves and heating the mixture at an ordinary temperature or room temperature (up to 40° C.) for extraction for 1 to 14 days (e.g., 7 days). The obtained extraction liquid is cooled and filtered. Then, the filtrate is concentrated to dryness.

The term “bamboo vinegar (or bamboo vinegar liquid)” refers to a liquid obtained by collecting fumes, which are by-products generated during the production of bamboo charcoal, from a charcoal burner, and subjecting the fumes to cooling and distillation or the like. The bamboo vinegar used herein may be a commercially available product such as a No. 3 bamboo vinegar liquid (Miyazaki Doko Co., Ltd.) or a high-quality bamboo vinegar liquid (Takesumi Kobo Mugengama).

CSL is a by-product generated during production of cornstarch, and it is obtained by concentrating a soak solution comprising soluble components eluted from corn and components generated via lactic acid fermentation in the soaking step of corn wet milling known as the cornstarch purification method. The CSL used herein may be a commercially available product such as a corn steep liquor powder (Oriental Yeast Co., Ltd.) or corn steep liquor (San-ei Sucrochemical Co., Ltd.).

The uricase inhibitor of the present invention may contain, for example, a deodorant, a component that enhances deodorant effects, a microorganism that promotes composting, and other materials, in addition to a uricase-inhibiting substance.

In addition, the content of a uricase-inhibiting substance in the uricase inhibitor of the present invention can be adequately determined depending on the purposes of the use of the inhibitor.

A method for evaluating uricase inhibitory effects of the uricase inhibitor of the present invention comprises, for example, adding the uricase inhibitor of the present invention to a reaction solution containing uricase and uric acid serving as a substrate of uricase and evaluating the uricase activity inhibitory effects based on the amount of uric acid that disappears as a result of a reaction between uric acid and uricase. For instance, if the amount of uric acid that disappears in a reaction solution to which the uricase inhibitor of the present invention has been added is significantly lower than that in a reaction solution to which the uricase inhibitor of the present invention has not been added, it can be determined that the uricase inhibitor of the present invention has favorable uricase inhibitory effects.

Meanwhile, the method for producing compost of the present invention (hereinafter referred to as “the method of the present invention”) comprises composting excrement containing uric acid to which at least one uricase-inhibiting substance selected from the group consisting of eucalyptus, a eucalyptus extract, bamboo vinegar, and CSL is added and producing compost by making use of the above uricase inhibitory effects of eucalyptus, a eucalyptus extract, bamboo vinegar, and CSL. According to the method of the present invention, the uricase activity of a uricase-producing bacterium can be inhibited during composting and thus compost having a slight or no ammonia odor can be provided.

Examples of excrement containing uric acid (hereinafter simply referred to as “excrement”) include excrement of animals such as humans and livestock (e.g., chickens, bovines, and pigs). Of these, poultry excrement is particularly preferable.

According to the method of the present invention, first, the uricase-inhibiting substance is added to excrement. The uricase-inhibiting substance can be added at any time prior to the composting step. For instance, in a case in which poultry excrement is used, the proportion of the uricase-inhibiting substance to be added to excrement is adjusted to 0.5% to 20% (W/W) and preferably 1% to 10% (W/W) of the weight of excrement.

Next, the mixture of the uricase-inhibiting substance and excrement is subjected to composting. Composting is carried out by, for example, adding an inoculum (e.g., Geobacillus thermodenitrificans) or a plant-fiber-degrading enzyme (e.g., cellulase or xylanase) to a mixture of the uricase-inhibiting substance and excrement according to need, followed by fermentation. For example, fermentation is carried out at 40° C. to 80° C. (and preferably 50° C. to 70° C.) for 2 to 5 weeks (and preferably 3 to 5 weeks). Thus, compost having a slight or no ammonia odor can be produced.

An example of a method for evaluating an ammonia odor of compost produced by the method of the present invention is sensory evaluation. Specifically, a plurality of panelists check the smell of compost produced by the method of the present invention. If compost produced by the method of the present invention is evaluated as having a slight or no ammonia odor to a more significant extent than compost produced from excrement to which no uricase-inhibiting substance has been added, it can be determined that such compost produced by the method of the present invention is favorable because it has a slight or no unpleasant odor.

### EXAMPLES

The present invention is hereafter described in greater detail with reference to the following examples, although the technical scope of the present invention is not limited thereto.

### Example 1 Uricase Inhibitory Effects of Eucalyptus, a Hot Water Extract of Eucalyptus, Bamboo Vinegar, and CSL

1-1. Preparation of a hot water extract of eucalyptus

Purified water (500 mL) was added to dried eucalyptus leaves (Eucalyptus globulus) (50 g), followed by extraction at 95° C. to 100° C. for 2 hours.

The obtained extract was cooled and filtered. The filtrate was lyophilized. Thus, a hot water extract of eucalyptus (8.7 g) was obtained.

1-2. Uricase activity inhibitory test

Uricase activity inhibitory tests of eucalyptus, the hot water extract of eucalyptus obtained above, bamboo vinegar, and CSL were conducted. The eucalyptus used herein was leaves of Eucalyptus globulus. In addition, bamboo vinegar produced by Miyazaki Doko Co., Ltd. and CSL produced by San-ei Sucrochemical Co., Ltd. were used.

Uricase activity was determined with reference to the determination method described in JP Patent Publication (Kokai) No. 2008-24635 A. Specifically, uricase activity was determined based on changes in absorbance measured during a uricase reaction that causes disappearance of uric acid used as a substrate.

42 mM borate buffer (pH 8.0) containing Uric acid (40 μM), Triton X-100 (0.00083% (W/V)) and EDTA (0.83 mM) (2.5 mL), and a sample solution (containing a uricase-inhibiting substance) or purified water (0.3 mL) were preheated at 37° C. for 5 minutes. Then, an enzyme solution of uricase (0.5 mL) previously diluted with an enzyme diluent (50 mM borate buffer (pH 8.0) containing 0.001% (W/V) Triton X-100 and 0.1 mM EDTA) was added to the above preheated liquid mixture so as to initiate a uricase reaction. The reaction was carried out at 37° C. for exactly 5 minutes. Then, a 20% (W/V) KOH solution (0.2 mL) was added to the reaction solution to terminate the reaction. After the termination of the reaction, the reaction solution was subjected to absorbance determination at 290 nm (ΔOD test). Blind evaluation was carried out by adding the above enzyme diluent (0.5 mL) instead of the enzyme solution, carrying out the above procedures, and measuring absorbance at 290 nm (ΔOD blank). The uricase activity inhibition rate for each sample was calculated by the following equation based on the obtained relevant absorbance.

### Uricase Activity Inhibition Rate Calculation Equation:

Uricase activity inhibition rate (%)=[1−(OD test−OD blank)/(OD test (purified water)−OD blank (purified water))]×100

Table 1 shows the results of the uricase activity inhibitory tests for the respective uricase-inhibiting substances.

TABLE 1
Uricase activity inhibition rates of the
respective uricase-inhibiting substances

| Uricase-inhibiting | | Uricase activity |
|---|---|---|
| substance | Final concentration | inhibition rate (%) |
| Bamboo vinegar | 10-fold diluted solution | 71.3 |
| | 100-fold diluted solution | 59.0 |
| | 1000-fold diluted solution | 23.5 |
| CSL | 10-fold diluted solution | 100.0 |
| | 100-fold diluted solution | 13.6 |
| | 300-fold diluted solution | 1.3 |
| Hot water extract of | 0.3 mg/mL | 100.0 |
| eucalyptus | 0.1 mg/mL | 86.9 |
| | 0.01 mg/mL | 1.7 |
| Eucalyptus | 1.5 mg/mL | 100.0 |
| | 0.5 mg/mL | 12.6 |
| | 0.01 mg/mL | 0.0 |

As shown in table 1, eucalyptus, the hot water extract of eucalyptus, bamboo vinegar, and CSL were found to have uricase activity inhibitory effects.

In addition, the pH of a stock solution prepared by dissolving bamboo vinegar in water was found to be pH 3.0. The pH of a 100-fold diluted solution thereof was found to be 3.5. The pH of a stock solution prepared by dissolving CSL in water was found to be 3.7. In addition, the pH of a solution prepared by dissolving the hot water extract of eucalyptus in water was found to be 4.6 at a concentration of 1 mg/mL and it was found to be 5.1 at a concentration of 0.1 mg/mL. Meanwhile, the pH of a solution prepared by dissolving a hot water extract of peat moss having no uricase activity inhibitory effects in water was found to be 3.5 at a concentration of 2 mg/mL. Thus, it was revealed that pH does not influence the uricase activity inhibitory effects.

### Example 2 Production of a Compost Containing Eucalyptus and Sensory Evaluation of the Smell of the Compost

A poultry excrement product that had been prepared by premixing poultry excrement and dried poultry excrement to adjust the moisture content to 50% to 60% (11 kg) was mixed with an inoculum (about 30 g) (material name: “Thermo master;” Toyota Roof Garden Co., Ltd.) and a plant fiber-degrading enzyme (about 20 g) (material name: “Tokubetsu Kyuko;” Toyota Roof Garden Co., Ltd.) with the use of a composting promoting system (“resQ45;” Toyota Roof Garden Co., Ltd.), followed by composting treatment using a composting test apparatus (“Kaguyahime;” Fujihira Industry Co., Ltd.). Composting was carried out for 10 days.

Upon composting, the degree of progression in composting was examined by comparing a eucalyptus-treated lot to which eucalyptus had been added prior to composting and a non-treated lot prepared for the Comparative Example by not adding any eucalyptus to poultry excrement. Eucalyptus used herein was leaves of Eucalyptus globulus. In addition, eucalyptus was added to poultry excrement such that it accounted for 5% (W/W) of the amount of poultry excrement.

After composting treatment, 10 panelists checked the smell of each compost for sensory evaluation. Table 2 shows the results. For sensory evaluation of the smell, the ammonia odor intensity was evaluated using a three-grade scale consisting of “Slight,” “Relatively slight,” and “No change.”

TABLE 2
Sensory evaluation of the ammonia odor of each compost

| | Ammonia odor | | |
|---|---|---|---|
| | Slight | Relatively slight | No change |
| Eucalyptus-treated lot | 8 persons | 2 persons | 0 person |
| Non-treated lot | 0 person | 1 person | 9 persons |

As shown in table 2, it was confirmed that compost obtained as a final product from the eucalyptus-treated lot had less ammonia odor than that obtained from the non-treated lot.

All publications, patents, and patent applications cited herein are incorporated herein by reference in their entirety.

1-6. (canceled)

7. A uricase inhibitor comprising at least one uricase-inhibiting substance selected from the group consisting of eucalyptus, a eucalyptus extract, bamboo vinegar, and corn steep liquor.

8. The uricase inhibitor according to claim 7, wherein the eucalyptus extract is a hot water extract of eucalyptus.

9. A method for producing compost comprising a step of composting excrement containing uric acid to which at least one uricase-inhibiting substance selected from the group consisting of eucalyptus and a eucalyptus extract is added.

10. The method according to claim 9, wherein the eucalyptus extract is a hot water extract of eucalyptus.

11. The method according to claim 9, wherein the excrement containing uric acid is poultry excrement.

12. A compost, which is produced by the method according to claim 9.
